(19) United States
(12) Patent Application Publication
(10) Pub. No.: US 2016/0321766 A1
(43) Pub. Date: Nov. 3, 2016

(54) PRINTER CONTROLLER FOR LOCATION BASED TARGETED ARTIFACT

(71) Applicant: RealtyMaps, LLC, Naples, FL (US)

(72) Inventors: Jon Rubinton, Naples, FL (US); Daniel Sexton, Naples, FL (US)

(21) Appl. No.: 15/200,339

(22) Filed: Jul. 1, 2016

Related U.S. Application Data
(63) Continuation-in-part of application No. 15/071,333, filed on Mar. 16, 2016.
(60) Provisional application No. 62/154,118, filed on Apr. 29, 2015.
(60) Provisional application No. 62/187,332, filed on Jul. 1, 2015.
(60) Provisional application No. 62/190,961, filed on Jul. 10, 2015.
(60) Provisional application No. 62/206,701, filed on Aug. 18, 2015.
(60) Provisional application No. 62/206,710, filed on Aug. 18, 2015.

(51) Int. Cl. G06Q 50/16; G06Q 30/02; G06F 3/12

(52) U.S. Cl. CPC G06Q 50/16; G06F 3/1206; G06F 3/1243; G06F 3/1292; G06Q 30/0261

(57) ABSTRACT

The present disclosure relates to an automated printer controller for generating hardcopy artifacts based upon a geospatial designation. The printer controller generates a Boundary associated with the Geospatial designation and a Person associated with the Boundary. More specifically, the present invention includes a print controller that determines a geospatial designation and associates the geospatial designation with geographic boundaries and further associates the geographic boundaries with a person in order to generate a physical artifact based upon, and specific to, the geographic boundaries and the person.

### CROSS REFERENCE TO RELATED APPLICATIONS

The present application claims the benefit of Ser. No. 15/071,333 filed Mar. 16, 2016, and entitled LOCATION BASED PRINT CONTROLLER WITH EXTERNAL DATA FOR AMENITIES, as a Continuation in Part Patent Application, which in turn claims priority to provisional patent application Ser. No. 62/154,118 filed Apr. 29, 2015 and entitled APPARATUS AND METHODS FOR TARGETED COMMUNICATION BASED ON PARCEL DATA WITH LAYERED DATA, and to provisional patent application Ser. No. 62/187,332 filed Jul. 1, 2015 and entitled PRINTER CONTROLLER FOR LOCATION BASED TARGETED ARTIFACT; and to provisional patent application Ser. No. 62/190,961 filed Jul. 10, 2015 and entitled LOCATION BASED PRINT CONTROLLER WITH EXTERNAL DATA; and to provisional patent application Ser. No. 62/206,701 filed Aug. 18, 2015 and entitled LOCATION BASED PRINT CONTROLLER WITH EXTERNAL DATA FOR AMENITIES; and to provisional patent application Ser. No. 62/206,710 filed Aug. 18, 2015 and entitled LOCATION BASED PRINT CONTROLLER WITH EXTERNAL DATA FOR GEOSPATIAL POLITICAL CONSIDERATIONS; the contents of each of which are relied upon and incorporated herein by reference.

### FIELD OF THE DISCLOSURE

The present disclosure relates to an automated printer controller. More specifically, the present invention includes a print controller that receives a user designated geospatial designation and associates the geospatial designation with geographic boundaries and further associates the geographic boundaries with a person in order to generate a physical artifact based upon, and specific to, the geographic boundaries and the person.

### BACKGROUND OF THE DISCLOSURE

Presently, hardcopy real estate based marketing generally consists of blanket mailings based upon a zip code. A real estate agent or broker will create market awareness about the agent and perhaps a list of properties for sale by the agent.

Obvious drawbacks inherent in such a system include the open ended communication style that is not addressed to a particular individual and does not- reference a geographic area specifically associated with an individual. A marketing agent may mail out hundreds or thousands of post cards or postal pieces and not be able to ascertain whether an intended audience has received the communication or the effect of the communication unless a recipient contacts the agent.

### SUMMARY OF THE DISCLOSURE

Accordingly, the present disclosure relates to a print controller and methods of operating the print controller to generate a hardcopy based upon a geospatial designation with boundaries that is associated with one or both an individual or a legal entity (a “person”). A physical artifact, such as a printed hardcopy is generated specific to the geospatial designation and the associated person. The physical artifact may include for example, a letter or other correspondence, a contract, a marketing piece or other property specific document. In some embodiments, the physical artifact may include an image of the geospatial designation.

According to the some embodiments of the present invention, a user may be at an initial geographic location, such as on a street front of a property and use a mobile device with a GPS capability to run an app that will capture a GPS location and transmit it to the printer controller.

In another aspect of the present invention, a mobile device may also include an image capture capability and a user may take a picture of a property the user is located on or adjacent to and simultaneously record a GPS location of the user. The user may submit the user's current location and the picture to an automated apparatus practicing the present invention. The automated apparatus may receive the image and the GPS location and identify one or more geospatial designations associated with the location. The geospatial designation, may include, by way of non-limiting example, one or more of: a street address, a property parcel, a neighborhood, a homeowners association, a town, a school district, a congressional district or other geospatial designation associated with the user's current location at the time of image capture.

According to the present invention, a user may select one or more geospatial designations from the list and generate hardcopy artifacts addressed to specific to persons associated with the selected geospatial designations.

Additional embodiments may include definition of geospatial designations based upon an area defined around an initial geographic location, such as by a radius around a point specified as the initial geographic location.

In some additional embodiments of the present invention, methods and apparatus are presented for aggregating, organizing, and layering data according to a relation to a real estate parcel and generating physical artifacts based upon aggregated data. The associated systems allow a user may sort and view parcels based on the layered data. In some embodiments, the layered data may comprise data from a variety of sources, such as, for example, government databases, such as tax or census records; public databases, such as the white pages; or subscription databases, such as a multiple listing service database.

More specifically, the present disclosure describes methods and apparatus for designating a location and boundaries of multiple geographic areas, such as real estate parcels, and generating physical artifacts based upon a selection of a designated geographic area.

The associated systems allow a user may sort and view parcels based on the layered data. In some embodiments, the layered data may comprise data from a variety of sources, such as, for example, government databases, such as tax or census records; public databases, such as the white pages; or subscription databases, such as a multiple listing service database.

The present invention provides apparatus and methods for acquiring providing information related to a parcel to a user. More specifically, the present disclosure describes a method of acquiring, organizing, and layering data related to a parcel, wherein a user may sort and view parcels based on the layered data. In some embodiments, the layered data may comprise data from a variety of sources, such as, for example, government databases, such as tax or census records; public databases, such as the white pages; or subscription databases, such as a multiple listing service database.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates a block diagram of geospatial designation and associated geographic boundaries.

FIG. 1A illustrates a diagram of a user with a position capture device for generating a geospatial designation.

FIG. 2 illustrates an exemplary position capture device and interactive user interface.

FIG. 3 illustrates a block diagram of a user with a position designation device with directional capability.

FIG. 4 illustrates a flow diagram with method steps that made be executed in some implementations of the present invention.

FIG. 5 illustrates a block diagram of a relationship between a geospatial designation and multiple geographic areas.

FIG. 6 illustrates aspects of controller hardware useful for implementing the present invention as a block diagram.

FIG. 7 illustrates an exemplary processing and interface system.

FIG. 8 illustrates a block diagram of an exemplary embodiment of a mobile device.

### DETAILED DESCRIPTION

The present invention provides a printer controller and methods of operating the printer controller to generate physical artifacts based upon a determined geospatial location and one or more sets of boundaries associated with the geospatial location. Each set of boundaries is in turn associated with a person. Upon command, the printer controller will generate an artifact specific to the geospatial location and a person predicated upon a choice of boundaries made by a user.

In some embodiments, additional information may be aggregated and associated with one or more of: a geospatial location; a set of boundaries, and a person. In some embodiments, methods of the invention may further include acquiring, organizing, and layering data related to a set of boundaries, such as a real estate property parcel, wherein a user may sort and view parcels and associated persons based on the layered data.

Glossary

“Person” as used herein, shall mean an individual, a corporate entity or other entity designated by law as a legal person.

“Geospatial Designation” as used herein shall mean an identifier of a specific point in relation to a geographic reference. Examples of a Geospatial Designation may include a spatial point system, such as a Cartesian Coordinate or a Polar Coordinate.

“Geospatial Designation Identifier” as used herein shall mean a device capable of identifying a Geospatial Designation, such as a point, in relation to a geographic area. Examples of a Geospatial Designation Identifier may include: a device specifically designed to provide Spatial Coordinates and a direction; an independent Global Positioning System Unit such as a Garmin™ TomTom™ or Magellan™; a smart device such as an iPhone™ or an Android™ phone. Other embodiments may include an Internet Access device such as a Personal Computer (“PC”) and an interactive graphical User Interface.

“Geographic Boundary” as used herein shall include a delineation of one or more Geographic Areas.

“Geographic Area” as used herein shall mean an area of land mass acknowledged by an accepted authority, or a specifically delineated geographic area. By way of non-limiting example, a land mass acknowledged by an accepted authority may include an area with legal boundaries, such as a real estate parcel, a township, a city, a county, a state, a political district, such as a congressional district, a homeowner's association or other area acknowledged defined by statute or bylaw. A specifically delineated geographic area may include any area input into a user interface or otherwise defined by a User, such as, all area within a defined distance from a specified point.

“Geopolitical Area” as used herein shall mean an area defined according to a political boundary, such as a township, a county, a voting district, a congressional district, a school district, or other legal boundary.

“Cartesian Coordinate” shall mean two coordinates that locate a point on a plane and measure its distance from either of two intersecting straight-line axes along a line parallel to the other axis.

“User interface” or “Web interface” is a set of graphical controls through which a user communicates with a Yearbooker. The user interface includes graphical controls such as button, toolbars, windows, icons, and pop-up menus, which the user can select using a mouse or keyboard to initiate required functions on the Yearbooker interface.

“Wireless” includes a communication protocol and hardware capable of digital communication without hardwire connections. Examples of Wireless include: Wireless Application Protocol (“WAP”) mobile or fixed devices, 3G, 4G, 5G, Bluetooth, 802.11, or other types of wireless capability.

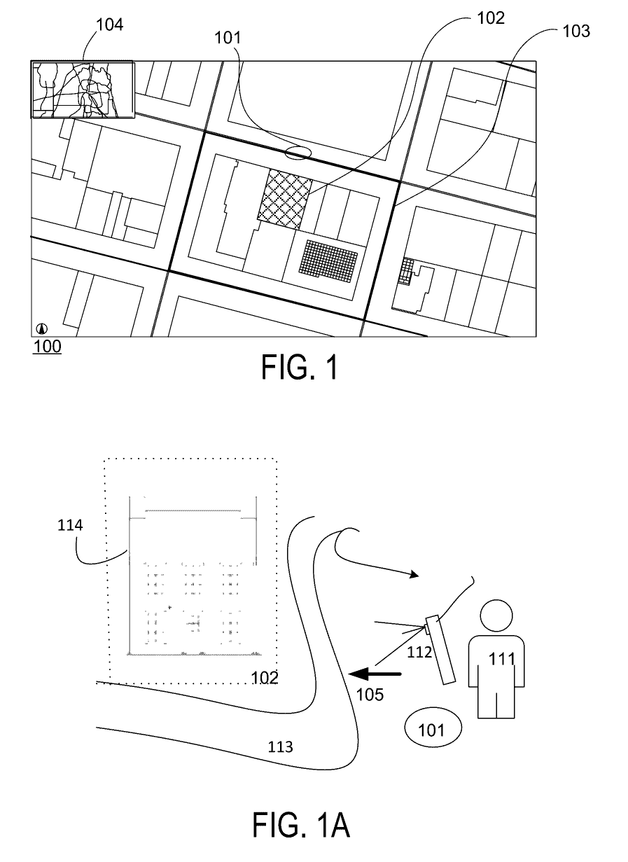

Referring now to FIG. 1, a functional diagram of some implementations of the present invention. According to the present invention a Geospatial Designation 101 is generated or otherwise specified by a user. As illustrated in this embodiment, the Geospatial Designation 101 is placed in the context of a real estate property parcel map 100. The geospatial designation 101 can be associated with one or more geographic areas. The geospatial designation 101 may be associated, for example with one or more of: a real estate property parcel 102, a neighborhood or homeowners association 103 and another geographic or geopolitical boundary. Each geographic and/or geographic boundary may be associated with a person. A Person may be an individual, a corporate entity or other entity designated by law as a legal person.

As discussed further below, association may be accomplished in an interactive database system wherein a Geospatial Designation 101 may be described in a mathematical sense, such as a spatial point defining system. Examples of a spatial point defining system may include a Cartesian Coordinate system or a Polar Coordinate system with a reference.

Referring now to FIG. 1A, in some embodiments, a User 111 may operate a Geospatial Designation Identifier device at a point along a roadway or other right of way, and generate a Geospatial Designation 101. In some embodiments, Geospatial Designation Identifier 112 may include an image capture device, wherein a User may capture a picture or other image of a Geospatial Designation and simultaneously capture a Geospatial Designation 101 and a direction of image capture 105 and a Field of View.

In some implementations, a subject 114 may be determined based upon the captured Geospatial Designation 101 and direction of image capture 105 and Field of View. The subject may thereby be associated with a Geospatial Designation.

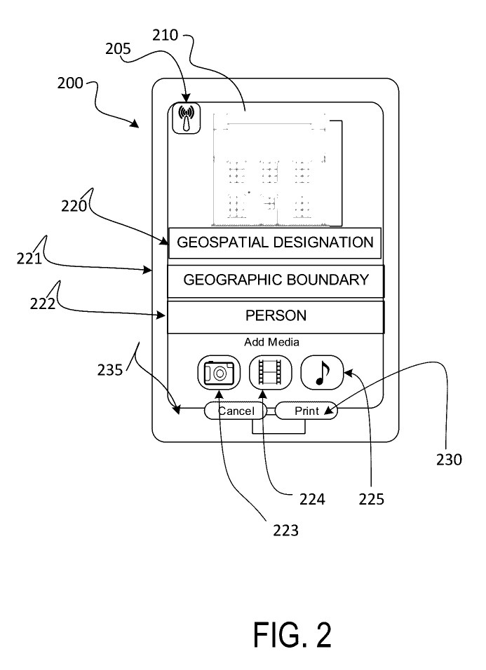

Referring now to FIG. 2, an exemplary Geospatial Designation Identifier 200 with functions of the Geospatial Designation Identifier 200 represented as a block type User Interface. It is understood by those schooled in the art that other User Interface designs, electromechanical control devices for functionality, and electronic control devices for functionality, are also within the scope of the present invention. For example, a function that includes generating a geospatial designation 220 may be accomplished via an electromechanical switch, an electronic switch or a programmed touchscreen.

Accordingly, in some embodiments, the Geospatial Designation Identifier 200 may include a device with User activated functionalities 220-225, 230 and 235. The functionalities may include a capability to generate a Geospatial Designation 220, generate a Geographic Boundary 221 associated and generate a designation of a Person associated with the Geographic Boundary 221 generated. As discussed above, in some embodiments, a Geospatial Designation Identifier 200 may also include media capture functionality 223-225 with the capability to capture one or more of: an image 223, a video 224 and an audio segment 225.

In another aspect, the Geospatial Designation Identifier 200 may also include a Wireless capability, such as, for example functionality that operates in accordance with a communication protocol for digital communication. Examples of Wireless functionality may include, by way of non-limiting example, one or more of: Wireless Application Protocol (“WAP”) for mobile or fixed devices, 3G, 4G, 5G, Bluetooth, 802.11, or other types of wireless.

In still another aspect, a Geospatial Designation Identifier 200 device may include a display to allow a User to view captured image data, such as a still image or picture; or a video.

Geospatial Designation Identifier 200 may therefore include a mobile device or a relatively stationary device, such as a personal computer, a laptop or a server device configured with appropriate hardware and software to provide functionality to generate one or more of: a Geospatial Designation 220, an associated Geographic Boundary 221 and an associated Person 222. In addition, the Geospatial Designation Identifier 200 may include additional hardware and software to capture one or more of: a static image 223; multiple image frames in a video context 224; and an audio segment 225.

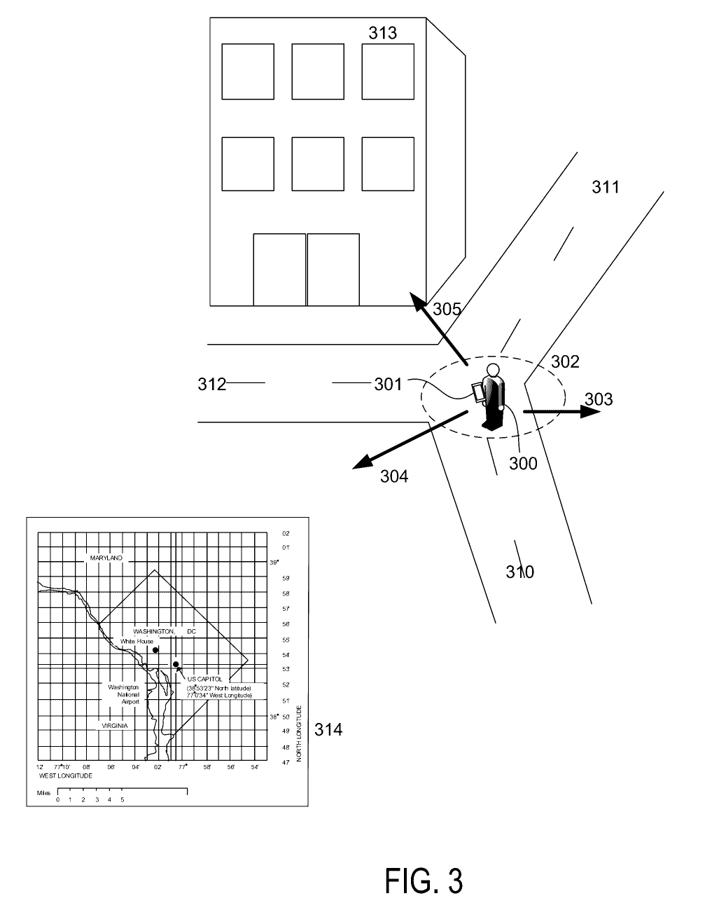

Referring now to FIG. 3, a close up view is illustrated of a User 300 with a handheld Geospatial Designation Identifier 301 and a Geospatial Designation 302 at an intersection with three roadways or other right of way 310-312. The handheld Geospatial Designation Identifier 301 may generate a Geospatial Designation 302. The handheld Geospatial Designation Identifier 301 may also generate a direction 303-305, or receive an input from a User indicating a direction 303-305. For example, in some embodiments a handheld Geospatial Designation Identifier 301 may include a directional indicator such as a compass. An interface with the User may allow a user to input a direction and the handheld Geospatial Designation Identifier 301 may correlate the input direction with mathematical representation of the input direction. The mathematical representation 314 may include for example, a value for directional degrees and minutes and be represented on the Geospatial Designation Identifier 301.

In addition, in some embodiments, a subject 313 of an image capture may also be generated and associated with one or more of: the Geospatial Designation 302; the direction 303-305 a Geographic Area (not illustrated in FIG. 3); and a designated Person (not illustrated in FIG. 3).

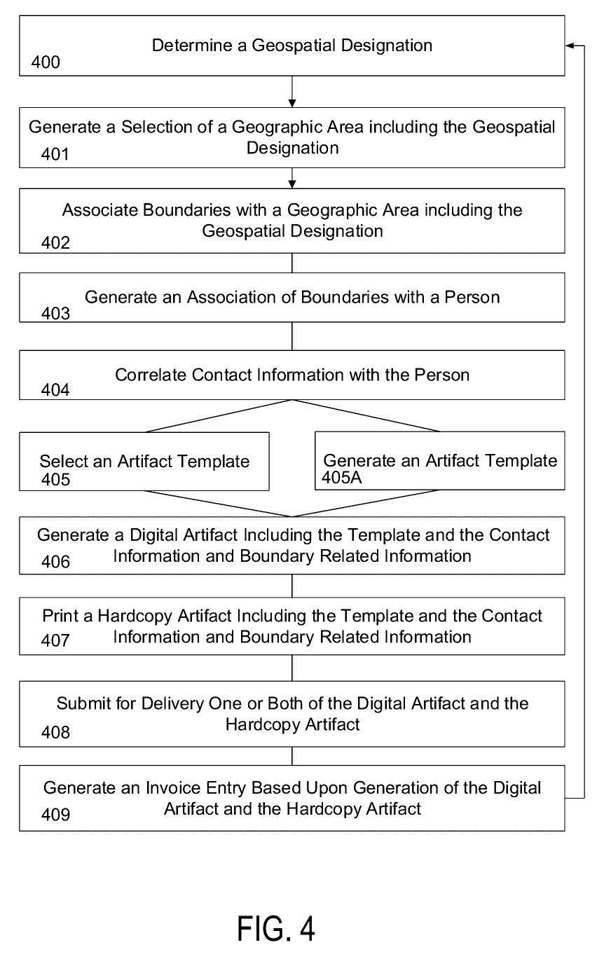

Referring now to FIG. 4, method steps that may be performed in some implementations of the present invention are listed. The method steps provided herein may be performed by one or more of: a printer controller, a special purpose computer, a Geospatial Designation Indicator a mobile network access device, and stationary network access device. At 400, a Geospatial Designation may be determined. The Geospatial Designation may be determined via a Geospatial Designation Identifier device, or via a selection by a User of a point on an image, such as for example a graphical user interface with representations of one or more real estate parcels, street addresses, property lines, street intersections and the like.

At 401, a Geographic Area is generated that includes the Geospatial Designation, as discussed herein, the Geographic Area, may be defined, by way of example, according to a User specified area type. The Geographic Area may be generated for example with a calculation that includes a User specified diameter, such as 0.5 miles or 5.0 miles around the Geospatial Designation. Other embodiments may include a User specified geopolitical area type associated with the Geospatial Designation, such as: real estate parcel, a real estate subdivision, within specified distance from the Geospatial Designation, a homeowners association, a township, a school district, a political district or other definable area.

At 402 one or more sets of Geographic Boundaries are associated with the Geographic Area including the Geographic Designation. The Geographic Boundaries may be selected via User instruction such as an alphanumeric entry or via graphical user interface menu or a point a click of a graphical image. For example a choice of a Geographic Boundary may be made via one or more of: a drop down menu, an outline on an interactive map, an alphanumeric description, a tax map number, a lot number in a sub-division platte, homeowners association, a township, a county, a state, a school district, political district, or other a Geopolitical Area. In some embodiments, designation of various Geographic Boundaries may be made by linking disparate databases according to the Geographic Designation and an area included within a Geographic Boundary.

At 403, an association is generated of one or more of the selected Boundaries with a Person. The Person may be an individual, such as a property owner or a head of an organization, or it may be an organization, such as a corporate entity. The association of the Person with the Geographic Boundary may be generated based upon the Person's relationship with the Geographic Boundary selected by the User. In some embodiments, the association of the Person with the Boundary may be generated by linking disparate databases according to one or more of: the Geographic Designation and the Geographic Boundary.

At 404, contact information for the Person associated with the Boundary may be correlated with the Person and the associated Boundary. Contact information may be correlated via the establishment of database links in a same or disparate databases. The Contact information provides an address to which an artifact destined for the Person may be mailed. The mail may by hardcopy mail, in which case the address will include a postal address or a street address. The mail may also be digital, in which case the address may be an electronic address, such as, one or more of: an email address, a social media address, a virtual private network address, a text message address or other electronic destination that may be associated with a person and receive an artifact.

At 405 and 405A an Artifact Template may be selected by a User 405 or generated by a User 405A. The Artifact Template will typically be a document, such as, one or more of: a letter, a contract, a sales offer, an offer to purchase and an advertisement marketing a product or service. However, in other implementation, the present invention may generate other tangible artifacts, such as signage or an image replication.

Selection of an Artifact Template 405 may be made via a drop down list or other user interface. In some implementations, a User may provide input indicative of a purpose of the Artifact and the Printer Controller may present options to the User with options to the User based upon an indicated purpose. Other implementations may include an alphanumeric identifier of a template wherein the User may provide the identifier and the identified Template will be combined with the Boundary information and the Person information to generate an Artifact. The Artifact Template made be generated 405A, for example, via a word processor, or design or presentation software, or be derived from a captured image such as a scanned document or image.

At 406 a Digital Artifact is generated which includes the Artifact Template and the Contact Information for the Boundary Information. The Digital artifact includes a digital representation of a desired Hardcopy Artifact that will be generated.

At 407, the printer controller provides instructions which cause a hardcopy artifact to be printed, or otherwise created, based upon the Artifact Template, the Contact Information and the Boundary Related Information.

At 408, one or both of the Hardcopy Artifact and the Digital Artifact are submitted for delivery to the Person associated with the Boundaries via the Contact Information linked to the Person. The step of submitting for delivery may include posting a Hardcopy Artifact via a parcel carrier service or an authorized postal mail service.

At 409, the print server may automatically generate an invoice entry based upon the generation of one or both of: the Digital Artifact and the Hardcopy Artifact. The invoice entry may include an invoiced amount based upon one or more of: the complexity of the generation of the Digital Artifact and the Hardcopy Artifact; inclusion of an image of a Geographic Area, a size of the Digital Artifact and/or the Hardcopy Artifact; an amount charged for delivery; a number of recipients or other cost of goods variable.

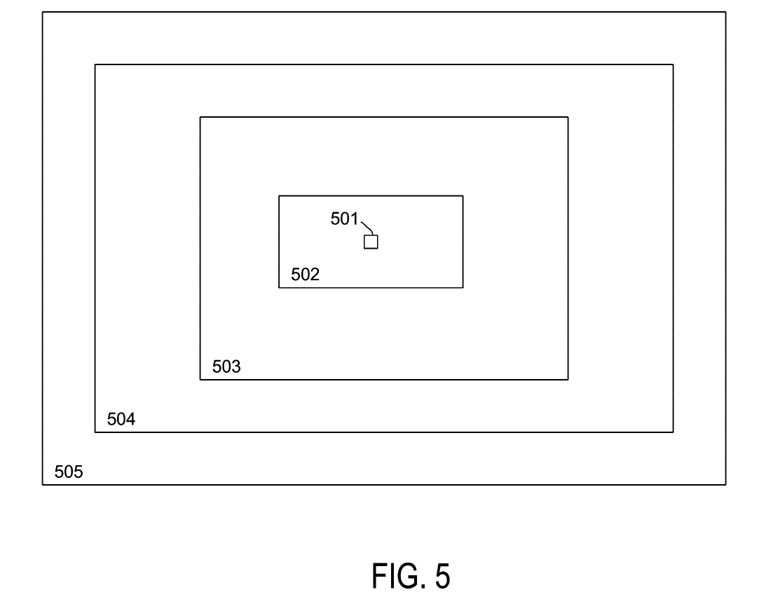

Referring now to FIG. 5, a block diagram of a Geospatial Designation 501 and multiple Geographic Areas are illustrated. The location of the Geospatial Designation 501 may be described in a mathematical sense, such as a spatial point with a base reference. In some embodiments, the location of the Geospatial Designation 501 a may also be expressed in relation to one or more of the Geographic Areas. Examples of a mathematical representation of the Geospatial Designation 501 may include a Cartesian Coordinate, such as a defined latitude and longitude. Another example may include a Polar Coordinate system with a vector value in combination with a start point and an angle. A defined Cartesian Coordinate and/or the Polar Coordinate may then be associated with one or more defined areas that include point defined by the Cartesian Coordinate.

As illustrated Geographic Areas 502-505 may include increasingly expanding areas with a smallest area 502 being a subset of one or more larger areas 503-505. Intermediate areas 503-504 may include some smaller areas 502 and be included within a larger area 505. In other embodiments, a Geographic Area 502-505 may only overlap at the point of the Geospatial Designation 501.

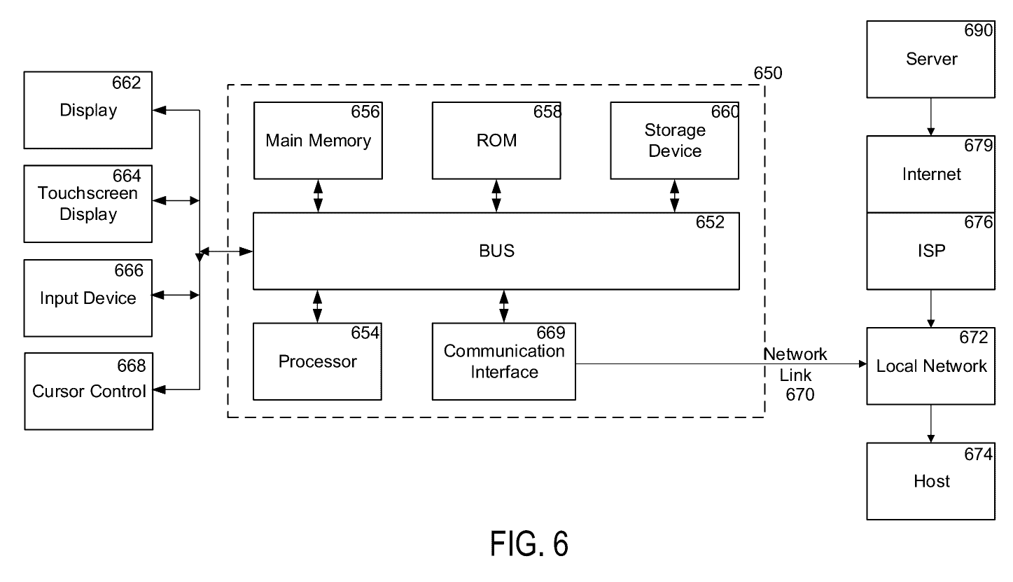

Referring now to FIG. 6, additional aspects of printer controller hardware useful for implementing the present invention are illustrated as a block diagram that includes a controller 650 upon which an embodiment of the invention may be implemented. Controller 650 includes a bus 652 or other communication mechanism for communicating information, and a processor 654 coupled with bus 652 for processing information.

Controller 650 also includes a main memory 656, such as a random access memory (RAM) or other dynamic storage device, coupled to bus 652 for storing information and instructions to be executed by processor 654. Main memory 656 may also be used for storing temporary variables or other intermediate information during execution of instructions to be executed by processor 654. Controller 650 further includes a read only memory (ROM) 658 or other static storage device 660.

Controller 650 may be coupled via bus 652 to a display 662, such as a cathode ray tube (CRT), liquid crystal display (LCD), plasma display panel (PDP), organic light-emitting diode (OLED), projector, or heads up display for displaying information to a computer user. An input device 666, including alphanumeric and other keys, may be coupled to bus 652 for communicating information and command selections to processor 654. Another type of user input device is cursor control 668, such as a mouse, a trackball, a touchpad, or cursor direction keys for communicating direction information and command selections to processor 654 and for controlling cursor movement on display 662. Another type of user input device is a touchscreen display 664 where a user may communicate information and command selections to processor 654 by tactile interaction with the display thereby controlling cursor movement or alphanumeric and other keys. This input device typically has two degrees of freedom in two axes, a first axis (e.g., x) and a second axis (e.g., y), that allows the device to specify positions in a plane.

Embodiments of the invention are related to the use of controller 650 for setting operational parameters relating to digital messaging and game playing. According to some embodiment of the invention, layering system parameters are defined and managed by controller 650 in response to processor 654 executing one or more sequences of one or more instructions contained in main memory 656. Such instructions may be read into main memory 656 from another computer-readable medium, such as storage device 660. Execution of the sequences of instructions contained in main memory 656 causes processor 654 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 654 for execution. Such a medium may take many forms, including but not limited to, non-volatile media, volatile media, and transmission media. Non-volatile media includes, for example, optical or magnetic disks, such as storage device 660 and 658. Volatile media includes dynamic memory, such as main memory 656. Transmission media includes coaxial cables, copper wire and fiber optics, including the wires that comprise bus 652. Transmission media may also take the form of acoustic or light waves, such as those generated during radio wave and infrared data communications.

Common forms of computer-readable media include, for example, a memory stick, hard disk or any other magnetic medium, a CD-ROM, any other optical medium, a RAM, a PROM, and EEPROM, any other memory chip or cartridge, or any other medium from which a computer may read.

Various forms of computer readable media may be involved in carrying one or more sequences of one or more instructions to processor 654 for execution. For example, the instructions may initially be carried on a magnetic disk of a remote computer. The remote computer can load the instructions into its dynamic memory and send the instructions over a distributed network such as the Internet. A communication device may receive the data on the telephone line, cable line, or fiber-optic line and use an infrared transmitter to convert the data to an infrared signal. An infrared detector can receive the data carried in the infrared signal and appropriate circuitry can place the data on bus 652. Bus 652 carries the data to main memory 656, from which processor 654 retrieves and executes the instructions. The instructions received by main memory 656 may optionally be stored on storage device 660 either before or after execution by processor 654.

Controller 650 also includes a communication interface 669 coupled to bus 652. Communication interface 669 provides a two-way data communication coupling to a network link 670 that may be connected to a local network 672. For example, communication interface 669 may operate according to the internet protocol. As another example, communication interface 669 may be a local area network (LAN) card allowing a data communication connection to a compatible LAN. Wireless links may also be implemented.

Network link 670 typically provides data communication through one or more networks to other data devices. For example, network link 670 provides a connection through local network 672 to a host computer 674 or to data equipment operated by an Internet Service Provider (ISP) 676. ISP 676 in turn provides data communication services through the worldwide packet data communication network now commonly referred to as the “Internet” 679. Local network 672 and Internet 679 both use electrical, electromagnetic or optical signals that carry digital data streams. The signals through the various networks and the signals on the network link 670 and through communication interface 669, which carry the digital data to and from controller 650 are exemplary forms of carrier waves transporting the information.

In some embodiments, Controller 650 may send messages and receive data, including program code, through the network(s), network link 670 and communication interface 669. In the Internet example, a server 690 might transmit a requested code for an application program through Internet 679, ISP 676, local network 672 and communication interface 669.

Processor 654 may execute the received code as it is received, and/or stored in storage device 660, or other non-volatile storage for later execution. In this manner, controller 650 may obtain application code in the form of a carrier wave.

Access devices may include any device capable of interacting with controller or other service provider. Some exemplary devices may include a mobile phone, a smart phone, a tablet, a netbook, a notebook computer, a laptop computer, a wearable computing or electronic device, a terminal, a kiosk or other type of automated apparatus. Additional exemplary devices may include any device with a processor executing programmable commands to accomplish the steps described herein.

A controller may be a programmable board such as an arduino board, and/or one or more of: personal computers, laptops, pad devices, mobile phone devices and workstations located locally or at remote locations, but in communication with the system. System apparatus can include digital electronic circuitry included within computer hardware, firmware, software, or in combinations thereof. Additionally, aspects of the invention can be implemented manually.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors.

Generally, a processor will receive instructions and data from a read-only memory and/or a random access memory. Generally, a computer will include one or more mass storage devices for storing data files; such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EEPROM and flash memory devices; magnetic disks such as, internal hard disks and removable disks; and CD ROM disks. Any of the foregoing can be supplemented by, or incorporated in, ASICs (application-specific integrated circuits).

In some embodiments, implementation of the features of the present invention is accomplished via digital computer utilizing uniquely defined controlling logic, wherein the controller includes an integrated network between and among the various participants in Process Instruments.

The specific hardware configuration used is not particularly critical, as long as the processing power is adequate in terms of memory, information updating, order execution, redemption and issuance. Any number of commercially available database engines may allow for substantial account coverage and expansion. The controlling logic may use a language and compiler consistent with that on a CPU included in the medical device. These selections will be set according to per se well-known conventions in the software community.

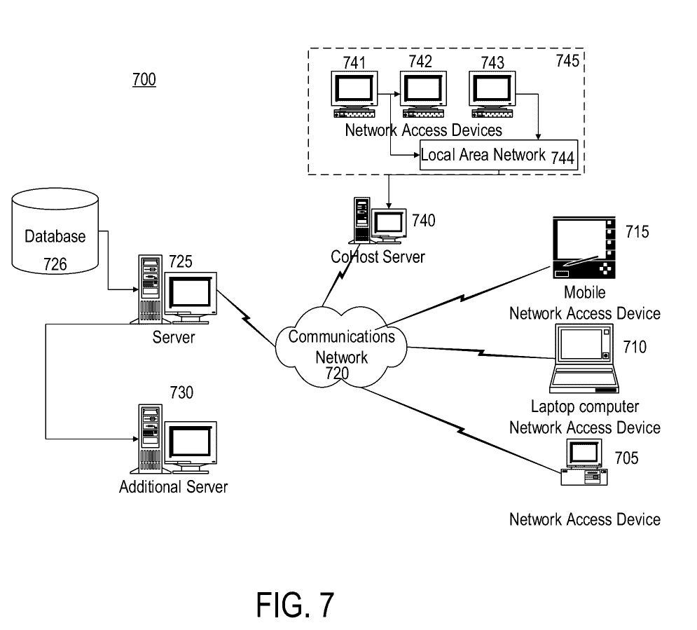

Referring now to FIG. 7, an exemplary processing and interface system 700 is illustrated. In some aspects, access devices 715, 710, 705, such as a mobile device 715 or laptop computer 710 may be able to communicate with an external server 725 though a communications network 720. The external server 725 may be in logical communication with a database 726, which may comprise data related to identification information and associated profile information. In some examples, the server 725 may be in logical communication with an additional server 730, which may comprise supplemental processing capabilities.

In some aspects, the server 725 and access devices 705, 710, 715 may be able to communicate with a cohost server 740 through a communications network 720. The cohost server 740 may be in logical communication with an internal network 745 comprising network access devices 741, 742, 743 and a local area network 744. For example, the cohost server 740 may comprise a payment service, such as PayPal or a social network, such as Facebook or a dating web site.

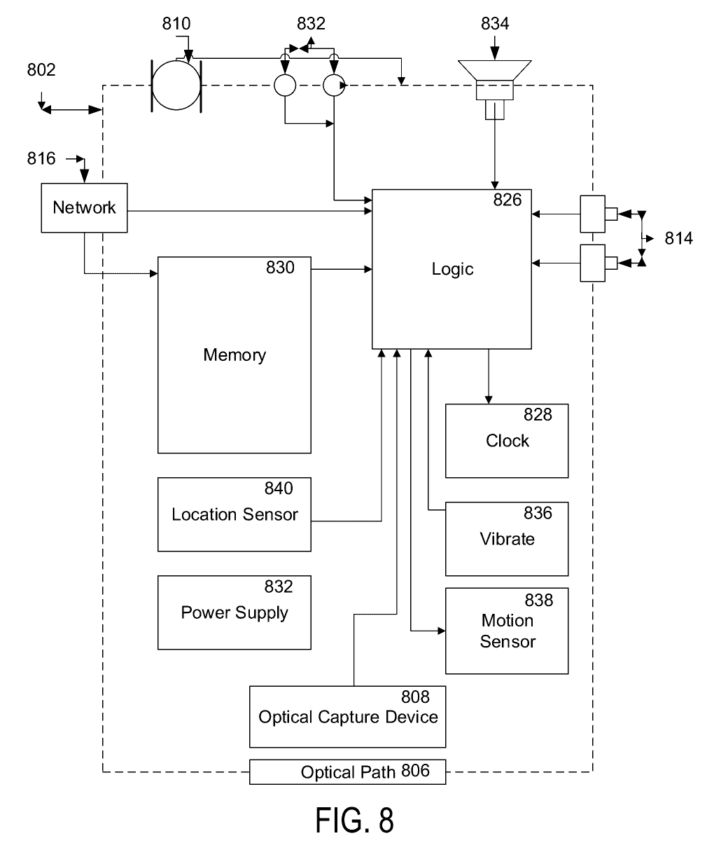

Referring now to FIG. 8, a block diagram of an exemplary embodiment of a mobile device 802 is illustrated. The mobile device 802 may comprise an optical capture device 808, which may capture an image and convert it to machine-compatible data, and an optical path 806, typically a lens, an aperture, or an image conduit to convey the image from the rendered document to the optical capture device 808. The optical capture device 808 may incorporate a Charge-Coupled Device (CCD), a Complementary Metal Oxide Semiconductor (CMOS) imaging device, or an optical sensor of another type.

In some embodiments, the mobile device 802 may comprise a microphone 810, wherein the microphone 810 and associated circuitry may convert the sound of the environment, including spoken words, into machine-compatible signals. Input facilities 814 may exist in the form of buttons, scroll-wheels, or other tactile sensors such as touch-pads. In some embodiments, input facilities 814 may include a touchscreen display. Visual feedback 832 to the user may occur through a visual display, touchscreen display, or indicator lights. Audible feedback 834 may be transmitted through a loudspeaker or other audio transducer. Tactile feedback may be provided through a vibration module 836.

In some aspects, the mobile device 802 may comprise a motion sensor 838, wherein the motion sensor 838 and associated circuity may convert the motion of the mobile device 802 into machine-compatible signals. For example, the motion sensor 838 may comprise an accelerometer, which may be used to sense measurable physical acceleration, orientation, vibration, and other movements. In some embodiments, the motion sensor 838 may comprise a gyroscope or other device to sense different motions.

In some implementations, the mobile device 802 may comprise a location sensor 840, wherein the location sensor 840 and associated circuitry may be used to determine the location of the device. The location sensor 840 may detect Global Position System (GPS) radio signals from satellites or may also use assisted GPS where the mobile device may use a cellular network to decrease the time necessary to determine location. In some embodiments, the location sensor 840 may use radio waves to determine the distance from known radio sources such as cellular towers to determine the location of the mobile device 802. In some embodiments these radio signals may be used in addition to and/or in conjunction with GPS.

In some aspects, the mobile device 802 may comprise a logic module 826, which may place the components of the mobile device 802 into electrical and logical communication. The electrical and logical communication may allow the components to interact. Accordingly, in some embodiments, the received signals from the components may be processed into different formats and/or interpretations to allow for the logical communication. The logic module 826 may be operable to read and write data and program instructions stored in associated storage 830, such as RAM, ROM, flash, or other suitable memory. In some aspects, the logic module 826 may read a time signal from the clock unit 828. In some embodiments, the mobile device 802 may comprise an on-board power supply 832. In some embodiments, the mobile device 802 may be powered from a tethered connection to another device, such as a Universal Serial Bus (USB) connection.

In some implementations, the mobile device 802 may comprise a network interface 816, which may allow the mobile device 802 to communicate and/or receive data to a network and/or an associated computing device. The network interface 816 may provide two-way data communication. For example, the network interface 816 may operate according to an internet protocol. As another example, the network interface 816 may comprise a local area network (LAN) card, which may allow a data communication connection to a compatible LAN. As another example, the network interface 816 may comprise a cellular antenna and associated circuitry, which may allow the mobile device to communicate over standard wireless data communication networks. In some implementations, the network interface 816 may comprise a Universal Serial Bus (USB) to supply power or transmit data. In some embodiments, other wireless links known to those skilled in the art may also be implemented.

As an illustrative example of a mobile device 802, a reader may scan some text from a newspaper article with mobile device 802. The text is scanned as a bit-mapped image via the optical capture device 808. Logic 826 causes the bit-mapped image to be stored in memory 830 with an associated time-stamp read from the clock unit 828. Logic 826 may also perform optical character recognition (OCR) or other post-scan processing on the bit-mapped image to convert it to text. Logic 826 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 826) to an associated computer via network interface 616.

As an example of another use of mobile device 802, a reader may capture some text from an article as an audio file by using microphone 810 as an acoustic capture port. Logic 826 causes audio file to be stored in memory 828. Logic 826 may also perform voice recognition or other post-scan processing on the audio file to convert it to text. As above, the reader may then upload the audio file (or text produced by post-scan processing performed by logic 826) to an associated computer via network interface 816.

### Conclusion

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A printer controller for generating hardcopy artifacts, the printer controller comprising:
a processor;
a main memory in logical communication via a digital bus with the processor, said memory storing executable software, the software operative with the processor to cause the printer controller to:
receive from a user interaction a Geospatial Designation;
generate a selection of a Geographic Area;
generate a Boundary for the Geographic Area associated with the Geospatial Designation;
generate an association of the Boundary for the Geographic Area with a Person;
correlate the Person with an address for receiving a hard copy delivery;
access a storage of information related to the Geographic Area designated;
associate the information related to the Geographic Area with a template; and
generate a hardcopy artifact including information related to: the Boundary, the template and the Person.

2. The printer controller of claim 1, wherein the printer controller receives an alphanumeric identifier of the template to be referenced in the generating of the artifact.

3. The printer controller of claim 1, wherein the printer controller is further caused to generate the template based upon input from a User.

4. The printer controller of claim 1, wherein the printer controller is further caused to:
provide instructions to submit the hardcopy artifact for delivery to the Person.

5. The printer controller of claim 1, wherein the printer controller is further caused to:
generate an invoice based upon the hardcopy artifact generated and the address receiving a hard copy delivery.

6. The printer controller of claim 1, wherein the printer controller is further caused to:
generate a Digital Artifact including the template and the Contact Information and the Boundary related information.

7. The printer controller of claim 1, wherein the Geographic Area comprises a real estate parcel.

8. The printer controller of claim 1, wherein the Geospatial Designation is determined based upon receipt of a digital image and a GPS location captured with a mobile device.

9. The printer controller of claim 1, wherein the Geospatial Designation is determined based upon information captured with a mobile GPS device and a directional device.

10. The printer controller of claim 1, wherein the Geospatial Designation is determined based upon a User input referencing an image representation of the Geographic Area.

11. A method for generating hardcopy artifacts specific to a user designated geographic area, the method comprising:
receiving a digital input based upon a user interaction and designating a Geospatial Designation;
generate a selection of a Geographic Area;
generating a Boundary for the Geographic Area associated with the Geospatial Designation;
generating an association of the Boundary for the Geographic Area with a Person;
correlating the Person with an address for receiving a hard copy delivery;
accessing a storage of information related to the Geographic Area designated;
associating the information related to the Geographic Area with a template; and
generating a hardcopy artifact including information related to: the Boundary, the template and the Person.

12. The method of claim 11, wherein the printer controller receives an alphanumeric identifier of the template to be referenced in the generating of the artifact.

13. The method of claim 11, additionally comprising the step of:
generating the template based upon input from a User.

14. The method of claim 11, additionally comprising the step of:
providing instructions to submit the hardcopy artifact for delivery to the Person.

15. The method of claim 11, additionally comprising the step of:
generating an invoice based upon the hardcopy artifact generated and the address receiving a hard copy delivery.

16. The method of claim 11, additionally comprising the step of: generating a Digital Artifact including the template and the Contact Information and the Boundary related information.

17. The method of claim 11, wherein the Geographic Area comprises multiple real estate parcels.

18. The method of claim 11, wherein the Geospatial Designation is determined based upon receipt of a digital image and a GPS location captured with a mobile device.

19. The method of claim 11, wherein the Geospatial Designation is determined based upon information captured with a mobile GPS device and a directional device.

20. The method of claim 11, wherein the Geographic Area comprises multiple real estate parcels and the Geospatial Designation is determined based upon at least one of: a User input referencing an image representation of the Geographic Area and information captured with a mobile GPS device and a directional device; and the method additionally comprises the steps of:
generating the template based upon input from a User;
providing instructions to submit the hardcopy artifact for delivery to the Person;
generating an invoice based upon the hardcopy artifact generated and the address receiving a hard copy delivery; and
generating a Digital Artifact including the template and the Contact Information and the Boundary related information.
